(19) United States
(12) Patent Application Publication
(10) Pub. No.: US 2009/0008924 A1
(43) Pub. Date: Jan. 8, 2009

(54) AUTHENTICATING BANKNOTES OR OTHER PHYSICAL OBJECTS

(75) Inventors: Willem Gerard Ophey, Eindhoven (NL); Boris Skoric, Eindhoven (NL); Pim Theo Tuyls, Eindhoven (NL); Antonius Hermanus Maria Akkermans, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/913,716

(22) PCT Filed: May 10, 2006
(86) PCT No.: PCT/IB06/51468

§ 371 Date: Nov. 6, 2007

(30) Foreign Application Priority Data
May 11, 2005 (EP) 05103928.7

(51) Int. Cl. G07D 7/12; G07D 7/20; B42D 15/10; G01N 21/01; G01N 21/93

(52) U.S. Cl. 283/85; 356/71; 382/135; 250/340; 250/372; 283/91

(57) ABSTRACT

A system 100 for authenticating a physical product 110, such as a banknote, including at least one physical product and a verification device 130. The physical product including a random distribution of a plurality of physically detectable particles 112 in a substrate of the product. In association with the physical product, a digital representation (114) is stored (‘stored representation’) of measured physical properties of the particles including an actual distribution of at least some of the particles, where the physical properties are measured through reflection and transmission. The verification device includes a measurement unit 450 for determining a digital representation (‘measured representation’) based on measurements of physical properties of the particles, including an actual distribution of at least some of the particles, through reflection and transmission; and a comparison unit 470 for comparing the measured representation with the stored representation.

### FIELD OF THE INVENTION

The invention relates to a system for authenticating a physical product, such as a banknote, the system including at least one physical product and a verification device. The invention further relates to a physical product for use in such a system. The invention also relates to a verification device for use in such a system. The invention also relates to a method of verifying an authenticity of a physical product.

### BACKGROUND OF THE INVENTION

Verifying the authenticity of a physical product has for a long time gained great interest. Many different authentication techniques are known for products, in particular for products with a high value, e.g. bank notes, cheques, credit cards, etc., and products providing access to or proving authenticity of another valuable product (e.g. authentication card for a software product) or providing access to a valuable service (e.g. a ticket for a theatre show, a football game, etc.).

For example, for a bank note many different features are used that enable simple authentication by a human. Examples of such features are watermarks, metal strips, complementary double-sided prints, fluorescent UV ink, etc. To keep ahead of fraudulent parties new generations of bank notes include additional features. To keep authentication simple, features are kept as much as possible the same for the different bank notes so that a human user can perform a quick visual scan of a bank note and compare it to a template. The human user may use a device fitted with a UV lamp assisting in the verification. Banks may use more advanced verification devices for verifying the authenticity of a bank note.

To increase the security of a physical product increasingly cryptographical techniques are used, for example by embedding a cryptographic processor in the product, such as a smart card. However such techniques are too expensive for certain products, particularly those produced in very high quantities, such as bank notes.

### SUMMARY OF THE INVENTION

It is an object of the invention to provide a system and method of the kind set forth that provides an enhanced security without having to embed an electronic circuit in the product.

To meet an object of the invention, the physical product includes a random distribution of a plurality of physically detectable particles in a substrate of the product;

the system includes, in association with the physical product, a digital representation (hereinafter referred to as ‘stored representation’) of measured physical properties of the particles including an actual distribution of at least some of the particles, where the physical properties are measured through reflection and transmission;

the verification device includes:

a measurement unit for determining a digital representation (hereinafter referred to as ‘measured representation’) based on measurements of physical properties of the particles, including an actual distribution of at least some of the particles, through reflection and transmission; and

a comparison unit for comparing the measured representation with the stored representation.

Security measures for, particularly cheap, physical products tend to be the same for each product. Although the features may be very difficult to copy, once a malicious party has been able to copy the feature, the copied product is ‘indistinguishable’ from the original. Some bank notes, such as the ten EURO note, include fluorescent particles that give visible light when irradiated by UV light. A human user, checking the note using a UV lamp to check the fluorescent ink on the note, will also see a distribution of some particles. This is a sign of a genuine bank note. The inventors have realized that this distribution of particles is inherently random and can be used for authenticating the bank note. It will be appreciated that a random distribution of particles can also be cheaply achieved in substrates of other products, such as a passport, credit card, theatre ticket, ticket to a sport event, etc. In itself a certain randomness on a physical product has been used for authentication purposes, e.g. Baoshi Zhu, e.g. “Print signatures for document authentication”, Proceedings of the 10th ACM conference on Computer and communication security, 2003, pp. 145-154, describes using randomness in toner distribution of a laser printer for authentication. Typically, such techniques perform one measurement on the surface of the object and are subject to fraudulent techniques on the surface that mimic the measurement. For example, in principle it is possible to mimic the UV image obtained from reflection of a bank note by using fluorescent UV ink on the note to print such a pattern. The same holds for a single measurement through the substrate of the product. Again such a measurement can frequently be mimicked by suitably treating the surface of the product. Inserting particles in a predetermined pattern in a substrate is considerably more complicated since inherent to the production process is that those particles are randomly distributed. To check that the measured properties are really caused by particles in the product substrate, according to the invention at least one reflective measurement and one transmission measurement is taken. The measurements are then represented in a digital form, which may but need not be human readable.

According to the measure of dependent claim 2, the particles have a thickness substantially corresponding to a thickness of the substrate. In this way the particles can be embedded in the substrate and are still close enough to the surface to give a good reflective measurement.

According to the measure of dependent claim 3, the particles are of a type luminescent under irradiation with UV and/or IR light and the measured physical properties include a location of the radiation of the particles. Using particles that are non-visible under normal light conditions ensures that the product looks normal to a user, while at the same time the particles can easily be detected using an UV and/or IR light source for reflective measurement. The luminescence may be fluorescence and/or phosphorescence.

According to the measure of dependent claim 4, the stored representation is represented on the physical product. In this way, the product can be verified purely based on the product alone without requiring access to the stored representation in another way.

According to the measure of dependent claim 5, the product includes a product identification; the system including a database for storing the stored representation in association with the product identification; and the verification device being arranged to obtain the product identification from the product and to retrieve the associated stored representation from the database. In this embodiment no additional data needs to be stored on the product, keeping the manufacturing process simple.

According to the measure of dependent claim 6, the measurement unit is arranged to perform a noise-robust measurement. Using a noise-robust measurement system enables processing the data further using digital processing techniques that may rely on the fact that the measurement input is reliable, i.e. repeated measurements should give the same digital output, even if the product is subject to normal wear.

According to the measure of dependent claim 7, the noise-robust measurement unit is operated under control of helper data, such a measurement thresholds, for filtering-out noise in the measurements. By using helper data, the measurement process can be controlled to ensure that noise is removed.

According to the measure of dependent claim 8, the helper data is product-specific and is stored in association with the product. Preferably, when the product is measured for the first time to generate the stored representation also helper data is generated that ensures that this specific product can be measured reliably. By storing this helper data, it can be re-used during the verification.

According to the measure of dependent claim 9, the stored representation and the measured representation are a cryptographic hash of the respective measured properties according to a predetermined hash algorithm; the verification device including a cryptographic unit for calculating a hash of the measured properties; the comparison unit being arranged to compare the respective hashed measured properties. Storing a hash (i.e. a one-way function that normally can not be reversed) of the representation of the measured properties instead of the actual representation makes it impossible for malicious parties to determine the representation based on the product and thus try to determine a matching representation for an illegally copied product that by definition has its own random distribution of particles. The verification device may be used in a secure environment, e.g. a central bank for verifying bank notes. The verification device may also include a secure unit that performs the hashing and comparison. In that way, malicious parties can not determine the measurements associated with the product from stored information (the hash can normally not be reversed) and for a copied products with its own unique distribution a malicious party can not easily generate a corresponding hash that would match the stored information. Secure modules are well-known in the cryptographic world.

According to the measure of dependent claim 10, the stored representation depends on a selectable part of the measurements; the product being associated with a digital challenge representing on which selectable part of the measurements the stored representation depends; the verification device being arranged to retrieve the challenge associated with the product and to derive the measured representation in dependence on the retrieved challenge. The selection may be any suitable selection, such as which properties are used, e.g. which frequency of reflected/transmitted light is measured. Preferably, the selection includes which particles are represented in the measurement, e.g. which areas of the product are measured). This increases the uncertainty for malicious parties and thus makes it more complicated to make a fraudulent copy.

According to the measure of dependent claim 11, the physical product includes digital data for use by the verification device and associated with the product, such as helper data and/or a digital challenge and/or a stored representation, where the digital data is cryptographically signed. By digitally signing the data, it is more difficult for a malicious party to create valid data, since this would also require a valid signature. The signature is preferably based on an encryption key of an authority responsible for the product. For example, a central bank's key could be used for the signature. Signing should then take place in a secure environment.

According to the measure of dependent claim 12, the verification device is arranged to verify the digital signature and to only perform the authentication after having completed a positive verification of the signature. In this way, a malicious party first has to ‘break’ the signature before any attempt can be made on generating a valid representation of the measurements. For example, a malicious party could generate a fake product with its own random physical characteristics, generate corresponding digital data and sign it correctly. As long as the malicious part has not obtained the key for signing, generating a valid signature is practically infeasible.

According to the measure of dependent claim 13, the physical product includes digital data for use by the verification device and associated with the product, such as helper data and/or a digital challenge, where the digital data is encrypted. This is a further hurdle that would need to be taken by a malicious party. The verification device is arranged to decrypt the encrypted digital data.

An object of the invention is also met by providing a physical product for use in the system according to the invention and by providing a verification device for use in the system.

An object of the invention is also met by a method of verifying an authenticity of a physical product, such as a banknote, that includes a random distribution of a plurality of physically detectable particles in a substrate of the product and is associated with a digital representation (hereinafter referred to as ‘stored representation’) of measured physical properties of the particles including an actual distribution of at least some of the particles, where the physical properties are measured through reflection and transmission, where the method includes:

measuring physical properties of the particles, including an actual distribution of at least some of the particles, through reflection and transmission;

determining a digital representation of the physical product (hereinafter referred to as ‘measured representation’) based on the measured properties; and

comparing the measured representation with the stored representation.

These and other aspects of the invention are apparent from and will be elucidated with reference to the embodiments described hereinafter.

### BRIEF DESCRIPTION OF THE DRAWINGS

In the drawings:

FIG. 1 shows a block diagram of a system in which the invention may be employed;

FIG. 2 shows images of an exemplary physical product, in this case a bank note;

FIG. 3 shows a combined block diagram and flow chart of and embodiment of the authenticating device; and

FIG. 4 shows a combined block diagram and flow chart of and embodiment of the verification device.

### DETAILED DESCRIPTION OF THE PREFERRED EMBODIMENT

The system and method according to the invention provide an improved authentication of physical objects, such as bank note. The following two main steps are taken:

A location of randomly distributed particles in a substrate is measured and digitally represented as a kind of unique fingerprint. To ensure that the particles are actually in the substrate both reflection and transmission is measured.

A noise robust measuring technique is used that gives a same digital representation for successive measurements, preferably even for a reasonable amount of wear. The digital representation is kept secret and only a hash of the representation is made available to verification devices.

Both techniques may be used independently. For example, the second technique may also be used for other randomness (e.g. only measured through reflection, or only on the surface). In the remainder the description starts with a focus on the first technique. The second technique is described within the context of the first technique, but persons skilled in the art can easily apply the second technique outside that context. For the second technique, the physical product may be any suitable “physical token”, i.e. a physical object that can be probed by means other than memory access and the response to the probing depends on the physical structure of the object. This may be the internal and or external structure of the object. The probing may be any suitable probing and is not limited to reflection or transmission.

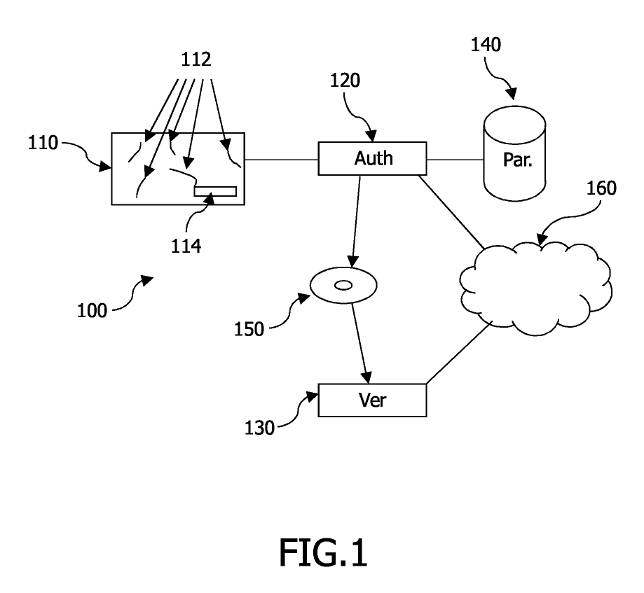

FIG. 1 shows a block diagram of a system in which the invention may be employed. The system 100 is used for authenticating a physical product 110, such as a banknote. The information required for the authentication is generated by a device 120 and the verification takes place by a verification device 130. According to the invention, the physical product 110 includes a random distribution of a plurality of physically detectable particles 112 in a substrate of the product. Preferably, the random distribution is achieved by mixing the particles with the main material elements of which the substrate is made (e.g. plastic particles or paper fibers) during the production of the physical product. This will give a random distribution, unique for each physical product. In this context, a main characteristic of the ‘random’ distribution is that it cannot be reliably reproduced. It is thus important that a production machine of a fraudulent party can not reproduce the distribution of a product with a reasonable effort (i.e. it can not create a physical product with the same distribution of particles as an already created product). To avoid any risk, it is preferred that also the own production machine can not reliably reproduce the same distribution (to avoid mis-use of the own machine). It is not relevant that the random distribution is not fully homogenous. The production process may result in certain areas having more particles than other areas (e.g. if the weight of the particles is not exactly the same as the weight of the main substrate material, this may give some inhomogeneity).

Advantageously, the particles are of a different material (or treated differently, e.g. painted/coated) than the main material particles to enable reliable and simple detection of the particles. Particularly if the particles can easily be identified in the substrate, the particles can also be made of the same material as the substrate.

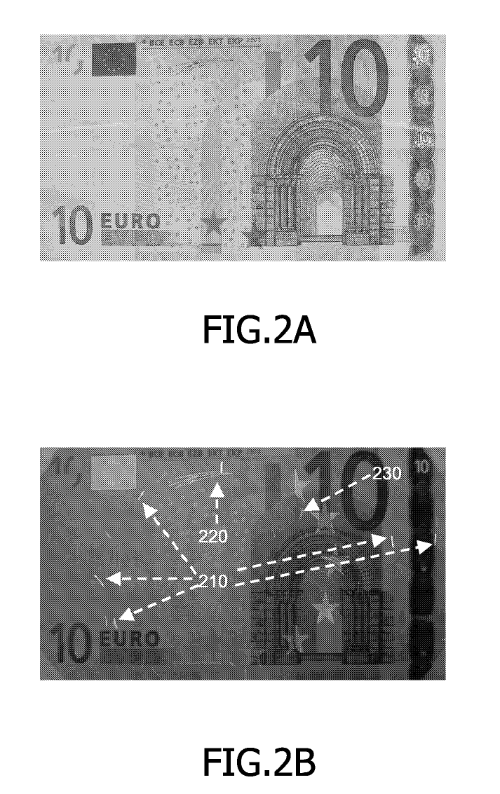

FIG. 2 shows an example of such a physical product with particles. FIG. 2A shows a black-and-white photo of a ten Euro note under normal lighting conditions. FIG. 2B shows the same note when illuminated with UV light. The photo is still registering the visible light spectrum. So, in this case some ink and the embedded particles are of a type that is fluorescent in response to being irradiated with UV light and responds in the visible spectrum. Items 210, 220 and 230 show some of the UV particles embedded randomly in the note.

According to the invention, physical properties of the particles are measured through both reflection of the substrate and transmission. Depending on the opacity of the substrate, reflection measurements reveal particles on or near the surface. Transmission is measured though the substrate and thus also provides information on particles measured through reflection. By comparing these two measurements it is possible to detect that the particles are actually embedded in the substrate and not mimicked by surface treatment of the substrate. If so desired, reflection may be measured on all surfaces of the substrate. Transmission may also be measured in any possible direction (e.g. front-to-back and back-to-front). The comparison of the measurements may include checking that a particle detected through reflection is sufficiently identifiable also through transmission. In a preferred embodiment, the particles have a thickness substantially corresponding to a thickness of the substrate. In this way most particles will be near the surface and also detectable through reflection. In such a case a higher degree of correspondence can be required to accept the product as genuine. If the particles have a thickness substantially smaller than the substrate thickness, a general coincidence of location is still required but the actual patterns of the measurements may deviate.

It will be appreciated that many choices are available for the substrate and the particles and thus also for the appropriate measurement techniques for identifying the particles. If detection is done with light, the substrate may be made of paper or plastic, for example. Depending on the thickness of the substrate the substrate may need a certain opacity to enable a reliable transmission detection. The particles may have been colored/coated with a suitable ink/coating. For light-based measurements, the particles may be visible under normal light, but may also be only visible in response to illumination with a UV and/or IR light source. The particles may also include metal. Instead of light other sources for measurement may be used, e.g. X-ray, microwaves, etc. In addition to transmission and reflection also other responses, such as for example known from MRI, may be used.

Referring to FIG. 1, the system 100 includes, in association with the physical product, a digital representation of the measurements, including at least an actual distribution of at least some of the particles. In addition to the location and/or orientation of particles many other properties of the particles may be used, for example a color (or more general ‘frequency response’) of reflection/transmission of the particles. By mixing particles of different color with the substrate material also a combination of colors may occur that is unique for the product. The digital representation is determined by device 120. The digital representation is stored in a suitable form to enable verification by the verification device. In a preferred embodiment, the digital representation is represented on the physical product, for example printed as a code in area 114 of FIG. 1. It may also be represented using electronic techniques, such as an RFID. Suitable electronic techniques for embedding a code in or on a substrate are well-known. For very cheap products, printing a representative code on the product is preferred. The verification device can simply retrieve the code using a suitable reading technique. Such techniques are well-known, e.g. using OCR techniques. The code may also take the form of a bar-code.

As an alternative to storing representation on/in the product itself it may be stored separately. To this end, the product includes a product identification. Suitable product identifications are well-known, for example printing a serial number on the product. The system 100 then includes a database 140 for storing the stored representation in association with the product identification. The verification device 130 is then arranged to obtain the product identification from the product and to retrieve the associated stored representation from the database. FIG. 1 shows two examples for this. In one example, the product identification and associated representation is stored in a storage 140, such as a hard disk, of for example a server 120 of a central authority 120 that also generated the representation. The representation can then retrieved by specially authorized verification devices 130 in an on-line manner through a network 160. Preferably, such a supply takes place in a secure manner. Secure exchange of data between a client 130 and a server 120 through a network 160 is well-known and will not be described here any further. Any suitable technique may be used. FIG. 2 shows as a second option that device 120 supplies the database (or part of it) via a storage medium 150 (e.g. a CD-ROM). Again, the data on the storage medium may be protected in a known way. The digital representation determined by device 120 will be referred to as ‘stored representation’ and as ‘response’.

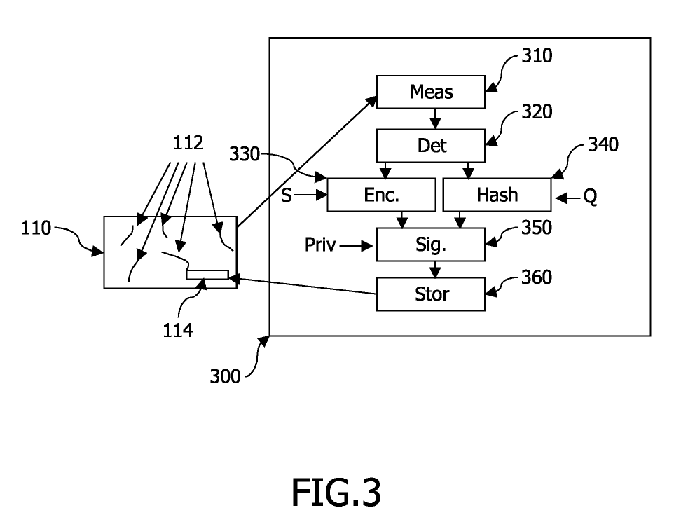

FIG. 3 shows that device 120, 300 includes a measuring unit 310 for performing the measurements. The measurement may be a photo of a reflection and a photo of the transmission. The invention focuses on the unique features of the physical product. To this end, features that are the same for each physical product may be removed. Any suitable technique may be used for this. For example, a color filter may be used to only keep features of a color of interest. Since also some feature of non-interest may have a same color a comparison with a template with all fixed features may be used to detect the variable features. Also pattern matching techniques may be used to identify and remove fixed features or, in the opposite, to identify particles. Based on the measurement a digital representation of at least some of the particles is made. A basic representation may take any suitable form. For example, the n largest (e.g. 10 largest) identified particles may be represented. The representation includes at least information on a location of the particle. The location information may be a central point of the particle. It may also include a bounding box (rectangular box narrowly enclosing the particle), or length of the particle. Location information may be relative to a fixed point (or points) and direction on the substrate, such as a predetermined corner. The representation may also include other measured properties of the particle, such as color. In this way for n particles at least n digital values are created. The combination then forms the basic digital representation. Other suitable properties include, but are not limited to, intensity, particle density, number of particles visible above a certain threshold intensity.

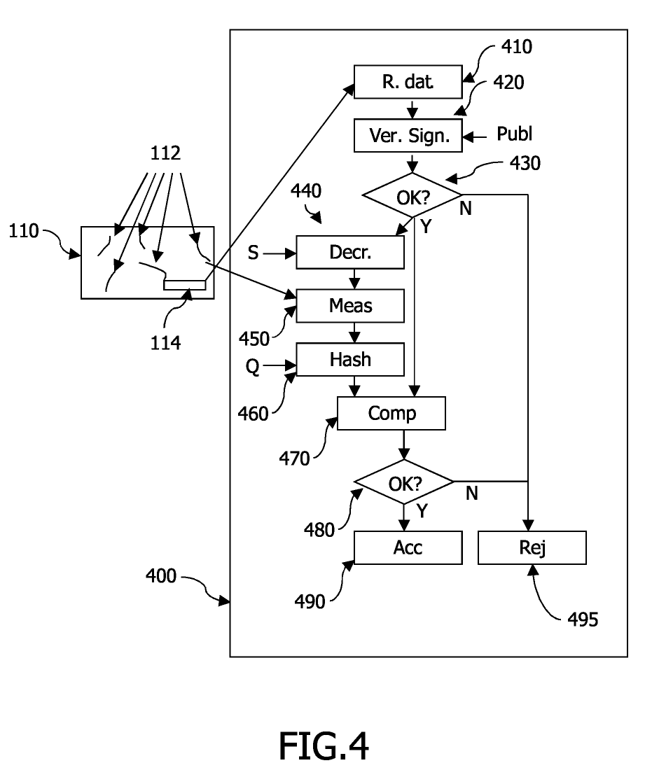

As also shown in a more elaborate embodiment of FIG. 4, in a basic form the verification device 130, 400 includes a measurement unit 450 for determining a digital representation (hereinafter referred to as ‘measured representation’) based on measurements of physical properties of the particles. As described above, also here the measured properties include information on an actual distribution of at least some of the particles and are measured through reflection and transmission. In this basic embodiment, the verification device 400 also includes a comparison unit 470 for comparing the measured representation with the stored representation. The product is only accepted as authentic if both match. This check is done in step 480. If OK, the product is accepted in step 490; otherwise it is rejected in step 495. The user is notified of this outcome. If rejected, preferably also an automatic signal is given to an authority that needs to be informed of a fraudulent copy. Such authority may for example be the police, or the central bank. Such notification may be done through a network such as Internet. Such a notification preferably at least takes place if the verification device repeatedly detects an illegal copy. This could be an indication that a malicious party has got hold of the device and is trying to break the protection. In response to detecting possible misuse, it is preferred that the verification device also disables itself. In embodiments described below in more detail, the verification device may include cryptographic keys. Preferably it permanently destroys such keys if misuse is suspected.

Preferably, the particles are of a type luminescent under irradiation with UV and/or IR light and the measured physical properties include a location of the radiation of the particles. The luminescence under irradiation is preferably in the visible spectrum to enable simple visual inspection by a human. The luminescence may be fluorescence or phosphorescence.

In a preferred embodiment, the measurement unit is arranged to perform a noise-robust measurement. As already described above, this technique is also applicable to any suitable “physical token”, i.e. a physical object that can be probed by means other than memory access and the response to the probing depends on the physical structure of the object. This may be the internal and or external structure of the object. The probing may be any suitable probing and is not limited to reflection or transmission. As such the invention relates to a system (100) for authenticating a physical product (110), such as a banknote, the system including at least one physical product and a verification device (130); the physical product including a random distribution of a plurality of physically detectable particles (112); the verification device (130) including a measurement unit (450) for determining a digital representation (hereinafter referred to as ‘measured representation’) based on measurements of physical properties of the particles, including an actual distribution of at least some of the particles, wherein the measurement unit is arranged to perform a noise-robust measurement. The invention also relates to a measurement unit (450) for determining a digital representation (hereinafter referred to as ‘measured representation’) of a physical product that includes a random distribution of a plurality of physically detectable particles (112); the measurement unit being arranged to determine the digital representation based on measurements of physical properties of the particles, including an actual distribution of at least some of the particles.

The noise-robust measurement may be achieved in any suitable way. For example, if the measurements are still in the analogue domain, thresholds that control the digitization (e.g. determine whether a pixel in a photo of the physical product should become a ‘0’ or a ‘1’ to indicate non-presence or presence, respectively, of a particle at that pixel location) may be chosen. In the digital domain, settings of a digital filter may be controlled. Also pattern recognition techniques may be used, so that only internal areas of particles are used and more noise-sensitive boundary areas are filtered-out. The measurement unit may also perform repeated measurements to detect, based on correlation, which data is reliable. Preferably, the noise-robust measurement unit is operated under control of helper data, such a measurement thresholds, for filtering out noise in the measurements. The helper data is associated with the product (e.g. stored on it), is used for removing noise, but does not reveal any information on the response of the product (i.e. on the measurements itself). Although relatively new, noise-robust measurement systems based on such crypto-graphic techniques have been described in:
Juels, M. Wattenberg, A Fuzzy Commitment Scheme, in G. Tsudik, ed., Sixth ACM Conference on Computer and Communications Security, 28-36, ACM Press. 1999.
J. P. Linnartz, P. Tuyls, New Shielding Functions to enhance Privacy and Prevent Misuse of Biometric Templates, Proc. 4th International Conference on Audio and Video based Biometric Person Authentication, LNCS 2688, Guildford UK, Jun. 9-11, 2003.

Persons skilled in the art can develop variations on such systems for other applications. Some of such helper data may be input (“settings”) to the measurement unit. Some of the helper data may also be determined during the measurement process, as a form of calibration. This may also be product-specific. For example, if a product has many clearly identifiable particles near the surface, then the filtering threshold may be set very “high” to remove any matter not near the surface. The threshold may need to be set lower, if not many particles are easily identifiable. Referring to FIG. 2B if the particles identified under number 210 provide enough data, the less visible particle 230 may be filtered out Helper data may include pointers to locations with a strong response. These location vary substantially between the products.

Particularly if the helper data is product-specific then this is stored in association with the product, e.g. represented on the product in field 114 or in the database 140 of FIG. 1.

In a preferred embodiment, the stored representation and the measured representation are a cryptographic hash of the respective measured properties according to a predetermined hash algorithm. So both device 120 that determines the stored representation and the verification device 130 calculate a hash of the measured properties. The devices thus include respective cryptographic units 340, 460 for calculating a hash of the measured properties. The units may be operated under the same cryptographic key Q. The units are preferably kept in a secure environment or implemented in a secure unit (e.g. embedded in a tamper proof IC). Since noise has been removed during the measurement process, a hash can be used. Without a noise-robust measuring the risk is too high that at least one bit of the measured data is changed. Hashing typically will cause many bits of the hashed value to be changed even if only one input bit is changed. By using a hash as the representation a malicious party can not normally retrieve the measurement values itself: a hash is irreversible. Any cryptographically secure hash may be used, for example SHA-1. The comparison unit 470 of the verification device 400 is arranged to compare the respective hashed measured properties.

In a preferred embodiment not all measured properties are used, but a selection is made. The stored representation thus depends on a selectable part of the measurements. For example, if there are more particles sufficiently identifiable than are required for a reliable representation then a selection may be made of particles that are going to be used. The selection is preferably done under control of a (pseudo-) random generator that selects which particles to use for this specific product. The selection may also remove particles that are difficult to detect such as particle 220 of FIG. 2B that overlaps with the UV signature of the bank director. The selection may also include which properties to use (e.g. location, color, intensity, particle density) and which measurement to use (only of the reflective measurements, one of the transmission measurements, all measurements, etc.). This may be chosen for all particles or may be chosen per particle. The selection that is made is represented digitally and will be referred to as the ‘challenge’. The product is thus associated with a digital challenge representing on which selectable part of the measurements the stored representation depends. Preferably, the challenge is product-specific. The challenge is stored in association with the product, e.g. it is represented on the product in field 114 of FIG. 1 or stored in database 140. The authenticating device 120 determines the challenge and the verification device 130 is arranged to retrieve the challenge associated with the product and to derive the measured representation in dependence on the retrieved challenge. The enrollment device 120, 300 includes a unit 320 for determining the settings such as the helper data and the challenge.

In an embodiment, the physical product 110 includes digital data for use by the verification device and associated with the product. This data may include the helper data and/or a digital challenge and/or the stored representation. According to the invention any such digital data is cryptographically signed. The signature is computed by the authenticating device 120. Any suitable cryptographical digital signature algorithm may be used, preferably a public key signature scheme, such as one based on RSA or elliptic curves. In this case, the signature is created by the enrollment device 120 using a private key of a responsible authority, like a central bank for bank notes. The key is indicated as Priv in FIG. 3. In this embodiment, the enrollment device thus includes a unit 350 for signing the involved digital data. The signature may be separate form the data. Alternatively an algorithm may be used that embeds the signature in the data itself, making the data no longer human interpretable. The data is then only retrieved during the verification of the signature. Preferably, the verification device 130 is arranged to verify the digital signature and to only perform the authentication after having completed a positive verification of the signature. The enrollment device thus includes a unit 420 for verifying the signature. This may take place under control of the public key, indicated as Publ. The test is shown in step 430. On a negative outcome, the product is rejected in step 495. Only on a positive outcome, processing is continued. The verification device includes a unit 410 for retrieving the data, e.g. from field 114 of the product 110 or from database 140. The enrollment device 300 includes a unit 360 for storing the data (in plain form, hashed, encrypted, signed, as is appropriate) on/in the product, e.g. by printing it on the product.

In an embodiment, some (or all) of the digital data represented on the physical product 110 for use by the verification device and associated with the product is stored in an encrypted form. This is preferably the case for the helper data and/or the digital challenge. As described above, the stored representation (“response”) is preferably represented as a hash. Any suitable encryption algorithm may be used. Preferably, a symmetric encryption scheme is used, such as triple DES. Advantageously, schemes are used that enable secure decryption by a group of verification. It will be appreciated that the digital signature is then calculated over the encrypted representation and not over the original data. The enrollment device 300 includes an encryption unit 330 for performing the encryption. If encryption is used, the verification device is arranged to decrypt the encrypted digital data. To this end it includes a decryption unit 440 for performing the decryption.

It will be appreciated that the invention also extends to computer programs, particularly computer programs on or in a carrier, adapted for putting the invention into practice. The program may be in the form of source code, object code, a code intermediate source and object code such as partially compiled form, or in any other form suitable for use in the implementation of the method according to the invention. The carrier may be any entity or device capable of carrying the program. For example, the carrier may include a storage medium, such as a ROM, for example a CD ROM or a semiconductor ROM, or a magnetic recording medium, for example a floppy disc or hard disk. Further the carrier may be a transmissible carrier such as an electrical or optical signal, which may be conveyed via electrical or optical cable or by radio or other means. When the program is embodied in such a signal, the carrier may be constituted by such cable or other device or means. Alternatively, the carrier may be an integrated circuit in which the program is embedded, the integrated circuit being adapted for performing, or for use in the performance of, the relevant method.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A system (100) for authenticating a physical product (110), such as a banknote, the system including at least one physical product and a verification device (130);
the physical product including a random distribution of a plurality of physically detectable particles (112) in a substrate of the product;
the system including, in association with the physical product, a digital representation (114) (hereinafter referred to as ‘stored representation’) of measured physical properties of the particles including an actual distribution of at least some of the particles, where the physical properties are measured through reflection and transmission;
the verification device (130) including:
a measurement unit (450) for determining a digital representation (hereinafter referred to as ‘measured representation’) based on measurements of physical properties of the particles, including an actual distribution of at least some of the particles, through reflection and transmission; and
a comparison unit (470) for comparing the measured representation with the stored representation.

2. A system as claimed in claim 1, wherein the particles have a thickness substantially corresponding to a thickness of the substrate.

3. A system as claimed in claim 1, wherein the particles are of a type luminescent under irradiation with UV and/or IR light and the measured physical properties include a location of the radiation of the particles.

4. A system as claimed in claim 1, wherein the stored representation is represented on the physical product.

5. A system as claimed in claim 1, wherein the product includes a product identification; the system including a database for storing the stored representation in association with the product identification; and the verification device being arranged to obtain the product identification from the product and to retrieve the associated stored representation from the database.

6. A system as claimed in claim 1, wherein the measurement unit is arranged to perform a noise-robust measurement.

7. A system as claimed in claim 6, wherein the noise-robust measurement unit is operated under control of helper data, such a measurement thresholds, for filtering-out noise in the measurements.

8. A system as claimed in claim 7, wherein the helper data is product-specific and is stored in association with the product.

9. A system as claimed in claim 6, wherein the stored representation and the measured representation are a cryptographic hash of the respective measured properties according to a predetermined hash algorithm; the verification device including a cryptographic unit for calculating a hash of the measured properties; the comparison unit being arranged to compare the respective hashed measured properties.

10. A system as claimed in claim 1, wherein the stored representation depends on a selectable part of the measurements; the product being associated with a digital challenge representing on which selectable part of the measurements the stored representation depends; the verification device being arranged to retrieve the challenge associated with the product and to derive the measured representation in dependence on the retrieved challenge.

11. A system as claimed in claim 1, wherein the physical product includes digital data for use by the verification device and associated with the product, such as helper data and/or a digital challenge and/or a stored representation, where the digital data is cryptographically signed.

12. A system as claimed in claim 11, wherein the verification device is arranged to verify the digital signature and to only perform the authentication after having completed a positive verification of the signature.

13. A system as claimed in claim 1, wherein the physical product includes digital data for use by the verification device and associated with the product, such as helper data and/or a digital challenge, where the digital data is encrypted; and the verification device is arranged to decrypt the encrypted digital data.

14. A physical product including a random distribution of a plurality of physically detectable particles (112) in a substrate of the product; and a digital representation (114) (hereinafter referred to as ‘stored representation’) of measured physical properties of the particles including an actual distribution of at least some of the particles, where the physical properties are measured through reflection and transmission.

15. A system (100) for authenticating a physical product (110), such as a banknote, the system including at least one physical product and a verification device (130);
the physical product including a random distribution of a plurality of physically detectable particles (112) in a substrate of the product;
the system including, in association with the physical product, a digital representation (114) (hereinafter referred to as ‘stored representation’) of measured physical properties of the particles including an actual distribution of at least some of the particles, where the physical properties are measured through reflection and transmission;
the verification device (130) including:
a measurement unit (450) for determining a digital representation (hereinafter referred to as ‘measured representation’) based on measurements of physical properties of the particles, including an actual distribution of at least some of the particles, through reflection and transmission; and
a comparison unit (470) for comparing the measured representation with the stored representation.

16. A verification device for authenticating a physical product including a random distribution of a plurality of physically detectable particles (112) in a substrate of the product using a digital representation (114) (hereinafter referred to as ‘stored representation’) of measured physical properties of the particles including an actual distribution of at least some of the particles, where the physical properties are measured through reflection and transmission;
the verification device (130) including:
a measurement unit (450) for determining a digital representation (hereinafter referred to as ‘measured representation’) based on measurements of physical properties of the particles, including an actual distribution of at least some of the particles, through reflection and transmission; and
a comparison unit (470) for comparing the measured representation with the stored representation.

17. A method of authenticating a physical product, such as a banknote, that includes a random distribution of a plurality of physically detectable particles in a substrate of the product and is associated with a digital representation (hereinafter referred to as ‘stored representation’) of measured physical properties of the particles including an actual distribution of at least some of the particles, where the physical properties are measured through reflection and transmission;
the method including:
measuring physical properties of the particles, including an actual distribution of at least some of the particles, through reflection and transmission;
determining a digital representation of the physical product (hereinafter referred to as ‘measured representation’) based on the measured properties; and
comparing the measured representation with the stored representation.
